(19) United States
(12) Patent Application Publication
(10) Pub. No.: US 2018/0150336 A1
(43) Pub. Date: May 31, 2018

(54) MANAGEMENT SYSTEM AND CONTROL METHOD

(71) Applicant: CANON KABUSHIKI KAISHA, Tokyo (JP)

(72) Inventor: Yuki Shirakawa, Mitaka-shi (JP)

(21) Appl. No.: 15/821,115

(22) Filed: Nov. 22, 2017

(30) Foreign Application Priority Data
Nov. 29, 2016 (JP) 2016-230824

(51) Int. Cl. G06F 9/50; G06F 9/48; G06F 9/455

(52) U.S. Cl. CPC G06F 9/5088; G06F 9/4806; G06F 2009/4557; G06F 9/45558; G06F 2009/45562; G06F 9/5033

(57) ABSTRACT

Management systems and control methods are provided herein. A management system determines a virtual machine to which a request is transferred from a load sharing apparatus. The management system transfers the request from a load sharing apparatus in a first processing environment to a virtual machine in a second processing environment when a setting of an apparatus which receives the request from the client is switched from the load sharing apparatus in the first processing environment to a load sharing apparatus in the second processing environment, and does not transfer the request from the load sharing apparatus in the first processing environment to a virtual machine in the first processing environment.

### BACKGROUND OF THE INVENTION

### Field of the Invention

The present disclosure relates to at least one embodiment of a management system which manages a processing environment including a virtual machine and a load sharing apparatus and a control method.

### Description of the Related Art

In recent years, the number of cloud services in which a user may use computer resources including applications, virtual machines, and storages as required as much as needed is increased. Such a cloud service is referred to as “SaaS” (software as a service), “PaaS” (platform as a service), or “IaaS” (infrastructure as a service) and the user may uniquely combine applications and computer resources provided by a cloud service vender. When the user may provide a service for an end user as a service vender by constituting a system in a cloud. The cloud service vender charges the user depending on the number of applications and computer resources used by the user.

In general, when a system is to be created, a system configuration is determined taking scales of functions and services to be provided into consideration and computer resources for operating applications are required to be selected. When the system configuration is to be changed in a course of operation of a service or when a machine specification is to be improved taking a load or performance of the system into consideration, computer resources are required to be changed or added. However, it is difficult to change or add computer resources in an environment in operation, and therefore, a stop time is provided taking deployment of setting files and programs in existing computer resources and switch-back of the system into consideration.

To address the provision of the stop time and to improve an operation mistake during operation, a system upgrading method referred to as “Blue-Green deployment” has been used in recent years. Here, the system upgrading includes upgrading of applications to be executed by virtual machines included in the system, for example. In the upgraded system, additional functions may be provided or types or formats of managed data are changed. Here, the virtual machines are logical computers which are obtained by dividing a server in a logical unit by a virtualizing technique irrespective of a physical configuration of the server and which operate with corresponding operating systems.

A method for upgrading the system by the Blue-Green deployment will now be described. First, a processing environment including an apparatus (a load balancer or a virtual machine) which is set to accept a request from a client in a cloud service functions as a production environment. A processing environment includes at least one virtual machine which processes requests and a load balancer functioning as a load sharing apparatus which distributes the requests to at least one virtual machine. When the processing environment is to be upgraded, a processing environment after the upgrading which is different from the processing environment of a current version is further created in the cloud service. Thereafter, at a time of upgrading, a setting of the apparatus which receives requests from a client is changed and a processing environment to function as a production environment is switched. By this switching, upgrading of the system is realized. Here, examples of a method for switching a connection destination include a method for rewriting a setting file including a domain name system (DNS) record of a DNS server managed by a service provider.

Japanese Patent Laid-Open No. 2016-115333 discloses a method for upgrading a system by the Blue-Green deployment.

Although a processing environment functioning as a production environment is switched by executing the Blue-Green deployment described above, a load sharing apparatus in an old production environment accepts a request from a client in some cases. This occurs when updating of a DNS server in a local network environment of the client delays or an old DNS cache remains in a cache server of the client as a setting of a client environment, for example. In such a case, when the client transmits a request, an old DNS record is used for name resolution. Then, although the processing environment functioning as a production environment is switched, the request from the client is received by the old production environment (a first processing environment) and may not be processed in a current production environment (a second processing environment). That is, an upgraded service is not provided for the client. The same is true of a case where the production environment is returned to the old processing environment (the second processing environment) due to occurrence of failure in the new processing environment (the first processing environment) immediately after the Blue-Green deployment is executed.

### SUMMARY OF THE INVENTION

The present disclosure provides at least one embodiment of a system in which, even when a request from a client is transmitted to a first processing environment, the request is processed by a virtual machine in a second processing environment by performing at least one setting in a client environment.

At least one embodiment of a management system according to the present disclosure determines a virtual machine to which a request is transferred from a load sharing apparatus. The management system transfers the request from a load sharing apparatus in a first processing environment to a virtual machine in a second processing environment when a setting of an apparatus which receives the request from the client is switched from the load sharing apparatus in the first processing environment to a load sharing apparatus in the second processing environment, and does not transfer the request from the load sharing apparatus in the first processing environment to a virtual machine in the first processing environment.

According to other aspects of the present disclosure, one or more additional management systems and one or more control methods are discussed herein. Further features of the present disclosure will become apparent from the following description of exemplary embodiments with reference to the attached drawings.

### BRIEF DESCRIPTION OF THE DRAWINGS

FIG. 1 is a diagram illustrating a configuration of a network system.

FIG. 2 is a diagram illustrating a configuration of hardware having an information processing function.

FIGS. 3A to 3C are diagrams illustrating a configuration of a cloud system.

FIGS. 4A to 4C are tables which manage setting values of computer resources.

FIG. 5 is a diagram illustrating a configuration of the cloud system after Blue-Green deployment.

FIG. 6 is a flowchart of a procedure of a deployment process.

FIG. 7 is a diagram illustrating a configuration of a cloud system according to at least second embodiment.

FIGS. 8A to 8C are tables managing versions of processing environments.

FIGS. 9A and 9B are a flowchart of a procedure of updating the version management tables.

FIG. 10 is a flowchart of a procedure of a process of deleting computer resources of old Blue.

### DESCRIPTION OF THE EMBODIMENTS

Hereinafter, preferred embodiments of the present disclosure will be described with reference to the accompanying drawings.

### First Embodiment

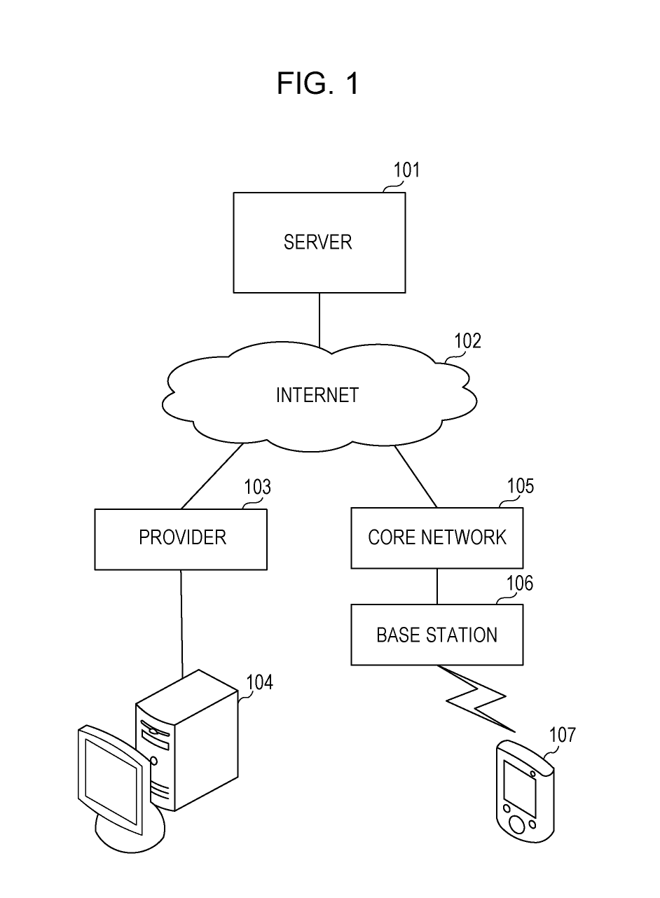

FIG. 1 is a diagram illustrating a configuration of a network system according to at least one embodiment of the present disclosure. An information processing apparatus 104 is a personal computer (PC), a printer, or a multifunction peripheral which communicates with a provider 103 using an optical line and which is connected to the Internet 102 through the provider 103. An information processing terminal 107 is a portable device, such as a tablet, a smartphone, or a laptop PC, for example, which communicates with a base station 106 in a wireless manner and which is connected to the Internet 102 through a core network 105. The information processing terminal 107 may be a desktop PC or a printer which has a wireless communication function. A server 101 functions as a cloud system which provides web pages and web application programming interfaces (APIs) for information processing terminals through the Internet 102. The cloud system of at least this embodiment provides a service for managing network devices constituted by platforms and resources provided by a cloud service, such as IaaS or PaaS, and customers who have the network devices. The cloud system may be constituted by a plurality of servers 101.

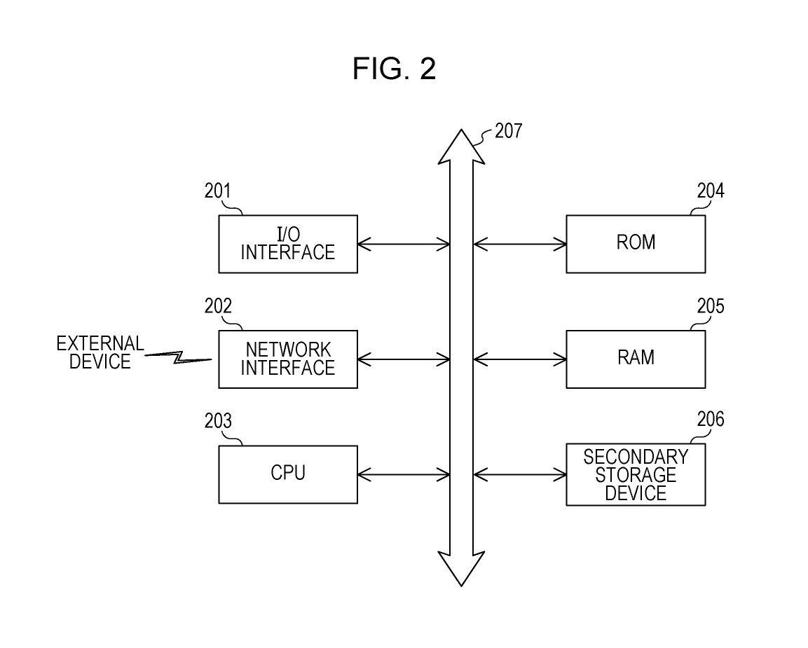

FIG. 2 is a diagram illustrating a configuration of hardware having an information processing function, such as the server 101, the information processing apparatus 104, the information processing terminal 107, and a server computer on a data center where the cloud system is constructed.

An input/output interface 201 performs input and output of information and signals by a display, a keyboard, a mouse, a touch panel, and buttons. A computer which does not include such hardware may be connected to and operated by another computer through a remote desk top or a remote shell. A network interface 202 is connected to a network, such as a local area network (LAN) so as to communicate with another computer or a network device. A ROM 204 records an embedded program and data. A RAM 205 is a temporary memory area. A secondary storage device 206 is represented by a hard disk drive (HDD) or a flash memory. A CPU 203 executes programs read from the ROM 204, the RAM 205, the secondary storage device 206, and the like. These units are connected to one another through an internal bus 207. The server 101 includes the CPU 203 which executes programs stored in the ROM 204 and integrally controls these units through the internal bus 207.

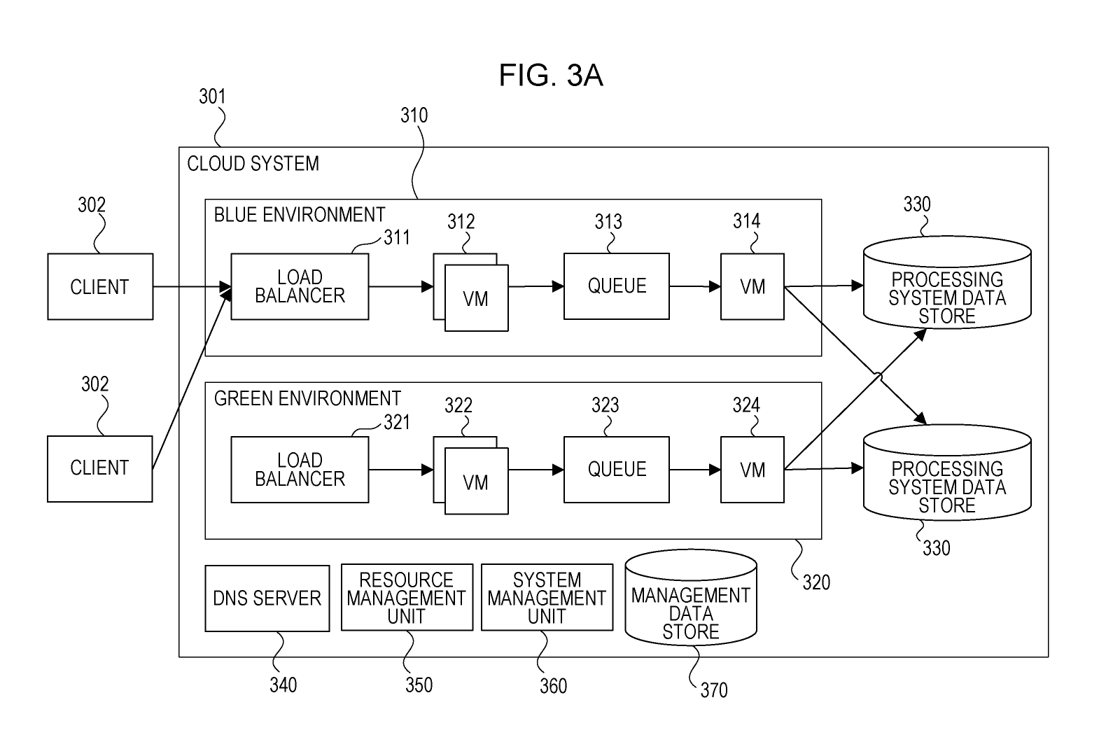

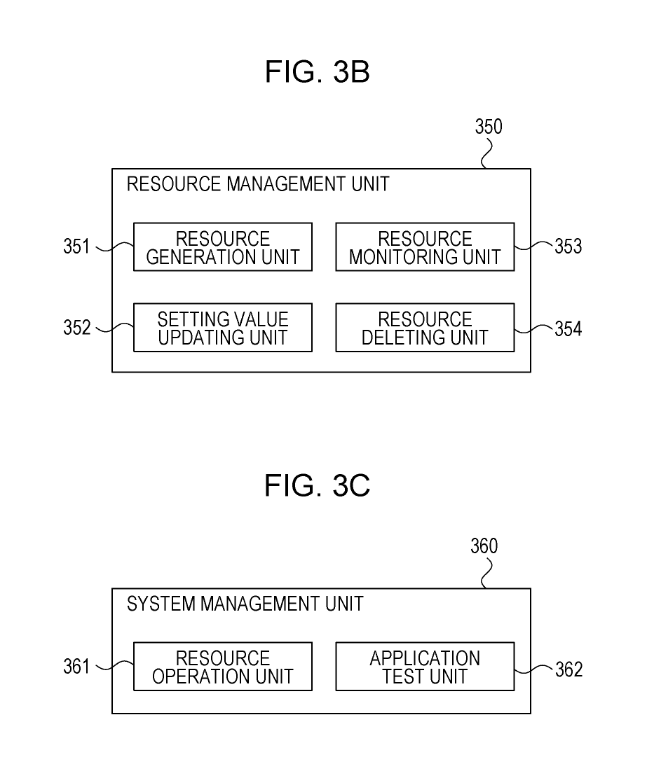

FIGS. 3A to 3C are diagrams illustrating a configuration of at least one embodiment of the cloud system. FIG. 3A is a diagram illustrating an entire configuration of the cloud system. A cloud system 301 is constituted by computer resources required for providing a service. A client 302 has information processing functions, such as the information processing apparatus 104 and the information processing terminal 107, and uses the service managed by the cloud system 301.

A processing environment 310 includes a load balancer 311, virtual machines 312, a queue 313, and a virtual machine 314. A setting for receiving a request supplied from the client 302 is performed on the processing environment 310 by a domain name system (DNS) server 340. In the setting performed by the DNS server 340, a processing environment including devices (a load balancer, a virtual machine, and the like) which has a setting for receiving a request from a client is referred to as a “Blue environment” or a “production environment” hereinafter. The load balancer (a load sharing apparatus) 311 in the Blue environment receives a request supplied from the client 302. It is assumed here that the load balancer 311 periodically executes health check on virtual machines which are request distribution destinations. In the health check, it is determined whether the virtual machines normally operate and whether communication with the virtual machines is available. The virtual machines (VMs) 312 are transfer destinations of requests supplied from the load balancer 311 and are capable of processing the transferred requests. Here, the virtual machines are logical computers obtained by dividing a server in a logical unit by a virtualizing technique irrespective of a physical configuration of the server and independently operate with respective operating systems. The VMs 312 may have a setting for automatically performing scale-out in accordance with the number of requests per unit time or a use rate of resources of the VMs 312.

The queue 313 stores data corresponding to processing requests of the VMs 312. The VM 314 periodically obtains and processes the data (a task or a message) stored in the queue 313. Unlike the VMs 312, the setting of automatic scale-out is normally not performed on the VM 314 due to presence of the queue 313. However, the setting of automatic scale-out may be performed in a case where the data stored in the queue 313 may not be processed within a predetermined period of time or a case where the queue 313 periodically performs dequeuing on the VM 314.

A processing environment 320 becomes a production environment after the execution of the Blue-Green deployment. Applications which are upgraded are operated in VMs in the processing environment 320 when compared with applications in the VMs in the processing environment 310. A processing environment which becomes a production environment after execution of the Blue-Green deployment is referred to as a “Green environment”. A load balancer 321 is included in the Green environment, and VMs 322 are distribution destinations of requests issued by the load balancer 321. Applications which are upgraded are operated in the VMs 322 when compared with applications in the VMs 312 in the Blue environment 310. A queue 323 stores data corresponding to processing request of the VMs 322. A VM 324 periodically obtains and processes the data stored in the queue 323. An application which is upgraded is operated in the VM 324 when compared with an application in the VM 314 in the Blue environment 310. In the Green environment, the client 302 does not normally transmit a request. However, a process in the Blue environment may be performed in the Green environment in a case where the client 302 or a system management unit 360 transmits a request while specifying an endpoint of the Green environment.

As described above, the Blue environment 310 and the Green environment 320 basically have the same configuration. However, the number of computer resources, a specification, and an application logic of the Green environment are changed relative to those in the Blue environment in accordance with the upgrading.

Here, a system constructed using a cloud service repeats upgrading in a comparatively short period in many cases and may be upgraded a few dozen times or hundreds of times per a day. Even in such a case, a service provider may easily perform change of computer resources and upgrading of applications without interruption by performing the Blue-Green deployment. Furthermore, since the service does not stop, the client may continuously use the service without taking changes performed on a service side into consideration.

When a connection destination is switched, a setting file is rewritten so that a connection destination of an external request is switched to a new production environment without changing a fully qualified domain name (FQDN). To perform name resolution based on an updated DNS record, the client may transmit a request to the new production environment without changing the FQDN. However, even if a service provider sets Time-to-Live (TTL) in a DNS server managed by the service provider, it is not necessarily the case that an update interval of the DNS server in a layer of an end user is ensured. For example, an old DNS record before updating is used in the name resolution in a case where the update delays in a specific DNS server in a local network environment of the client or a case where a DNS cache is held in a cache server of the client. Accordingly, the request issued by the user is processed in an old production environment which is an old version instead of a current production environment which is a new version.

Returning back to FIG. 3A, a data store 330 is used by the Blue environment 310 and the Green environment 320. A plurality of data stores 330 may be installed for the purpose of redundancy or different types of data stores in terms of system characteristics may be installed. Note that, although the data store is shared by the Blue environment and the Green environment in FIG. 3A, the processing environments may have respective data stores. The DNS server 340 manages domain information and association information of endpoints included in the cloud system 301 as a setting file including the DNS record and the like. A resource management unit 350 described below rewrites the setting file of the DNS server 340 so that the Blue-Green deployment for switching between the Blue environment and the Green environment is realized. Specifically, the resource management unit 350 rewrites the setting file of the DNS server 340 such that endpoints of the load balancers 311 and 321 are associated with the official FQDN of a service managed by the cloud system 301 so that the switching between the processing environments is performed.

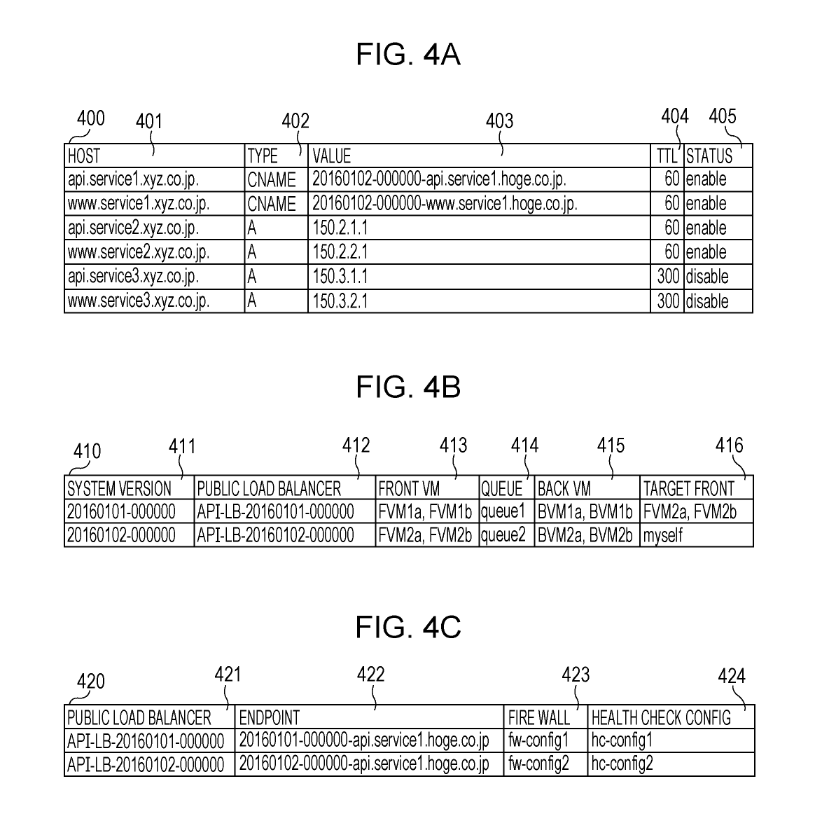

FIG. 3B is a diagram illustrating a configuration of the resource management unit 350. The resource management unit 350 performs monitoring and operation on the computer resources included in the cloud system 301 and is a function provided by a cloud service vender. A resource generation unit 351 has a function of generating the computer resources including the processing environments and the data store. A setting value updating unit 352 has a function of updating a setting file (refer to FIG. 4A described below) of the DNS server 340. The setting value updating unit 352 directly rewrites the setting file of the DNS server 340 or calls APIs provided by the computer resources so as to update setting values when receiving an instruction issued by a resource operation unit 361 of the system management unit 360. A resource monitoring unit 353 has a function of monitoring states of the computer resources in the cloud system 301, an access log, and an operation log. A resource deleting unit 354 has a function of deleting the computer resources in the cloud system 301. The resource deleting unit 354 may be set so that unrequired computer resources are periodically deleted by registering a deleting process in a scheduler in advance.

FIG. 3C is a diagram illustrating a configuration of the system management unit 360. The system management unit 360 issues an instruction for operating the computer resources in the cloud system 301 to the resource management unit 350. The system management unit 360 functions as a management system in this embodiment and is generated by a system developer who manages the cloud system 301. The system management unit 360 is capable of communicating with the DNS server 340, the resource management unit 350, and a management data store 370. The resource operation unit 361 receives a request issued by a development PC of the system developer who manages the cloud system 301 and issues an instruction for operating the computer resources of the cloud system 301 to the units included in the resource management unit 350 described above. The resource operation unit 361 manages a table (refer to FIG. 4B) for managing configuration information of the processing environments and a table (refer to FIG. 4C) for managing setting information of the load balancers of the processing environments. An application test unit 362 has a function of transmitting a request for a test of operation check and communication check of the processing environments to the processing environments. The application test unit 362 (hereinafter referred to as a “test unit 362”) supplies a test generated in advance by the service provider who manages the cloud system 301 to the management data store 370 or the like. The test unit 362 transmits a test request to an arbitrary processing environment using a test tool when a test is to be executed. Furthermore, the test unit 362 may cause the load balancers 311 and 321 to issue an instruction for executing a health check to the VMs 312 and 322 through the resource management unit 350. The management data store 370 is used for management and stores a management program of the resource operation unit 361 indicating an instruction, application programs of the processing environments 310 and 320, and data used and generated in the cloud system 301, such as an access log.

FIGS. 4A to 4C are diagrams illustrating tables which manage setting values of the computer resources. Although described hereinafter, the setting values in the tables in FIGS. 4A to 4C relate to states of the DNS server 340 and processing environments 510 and 520. Although the setting values are managed in a matrix form, such as a table form, in this embodiment, the setting values may be managed as a setting file of a key value form, such as JavaScript Object Notation (JSON).

A setting file 400 in FIG. 4A includes DNS records of the DNS server 340. The setting file 400 is stored in the DNS server 340. The client 302 performs name resolution based on the setting file 400. A column 401 includes a host name which is a destination of transmission of a request from the client 302 to the Blue environment 310. A column 402 includes a record type of a DNS record. A column 403 includes a destination of an endpoint which is associated with a host name set in the column 401. A column 404 includes a TTL indicating a period of time in which a DNS record is valid. A column 405 indicates whether a record is enabled or disabled.

A table 410 of FIG. 4B manages configuration information of the processing environments. The table 410 is stored in the management data store 370. The table 410 is updated by the resource operation unit 361 when the resource generation unit 351, the setting value updating unit 352, and the resource deleting unit 354 generate, update, and delete the processing environments and the computer resources in the processing environments. A column 411 includes a system version of a processing environment. The system version 411 is a unique ID for identifying a processing environment which is issued when the resource generation unit 351 generates the processing environment. A column 412 includes a unique ID of a load balancer which is externally disclosed and which is accessible from the client 302, such as the load balancer 311 or the load balancer 321. A column 413 includes a unique ID of a VM corresponding to a front-end server of a processing environment, such as the VM 312 or the VM 322. A column 414 includes a unique ID of a queue corresponding to a queue of a processing environment, such as the queue 313 or the queue 323. A column 415 includes a unique ID of a VM corresponding to a back-end server or a batch server of a processing environment, such as the VM 314 or the VM 324.

A column 416 includes a setting value indicating a VM which is a target of transfer of a request supplied from a load balancer in a processing environment. The load balancer in the processing environment transfers a request to one of VMs included in the column 416. A setting value in the column 416 is updated by the resource operation unit 361 after switching between Blue and Green. In the management table 410, a processing environment in a first row (a row including a system version of “20160101-000000”) indicates that a request is received by a load balancer described in the column 412, and thereafter, the request is transferred to a VM set in the column 416. In the processing environment in the first row of the table 410, the load balancer described in the column 412 transfers the request to a VM of the column 413 in a processing environment in a second row of the table 410. In the processing environment in the second row of the table 410, “myself” is described in the column 416, and therefore, a request is transferred in a VM in the same processing environment instead of a VM in another processing environment. Specifically, the table 410 manages the association between the load balancer in the column 412 and the VM in the column 416 which is a request transfer destination.

That is, the processing environment in the first row is an old production environment, the processing environment in the second row is a current production environment, and the load balancer in the old production environment transfers a request to the VM in the current production environment. The load balancer in the production environment transfers a request to the VM of the production environment as normal. Note that a table definition is changed depending on system configurations of the processing environments in the table 410, and therefore, a table which manages processing environment configuration information is not limited to a table definition of the table 410.

A table 420 in FIG. 4C manages setting information of the load balancers of the processing environments. The table 420 is stored in the management data store 370. The table 420 is updated by the resource operation unit 361 when the resource generation unit 351, the setting value updating unit 352, and the resource deleting unit 354 generate, update, and delete the load balancers. A column 421 includes a unique ID indicating a load balancer which is externally disclosed and which is accessible from the client 302, such as the load balancer 311 or the load balancer 321, and corresponds to the column 412. A column 422 includes a value indicating an endpoint of a load balancer, and a DNS name or an IP address is set in the column 422. A column 423 includes a setting value of a fire wall of a load balancer. As a setting value of a fire wall, a protocol or a port which permits communication or a rule of inbound or outbound are described in the column 423. A column 424 includes a setting value of health check. As a setting value of a health check, a destination and a port number of a request to be transmitted in a health check or a rule for a normal health check are described in the column 424. As a setting value of a fire wall and a setting value of a health check in the columns 423 and 424, respectively, setting files may be specified for the table 420 as illustrated in FIG. 4C or direct values may be set.

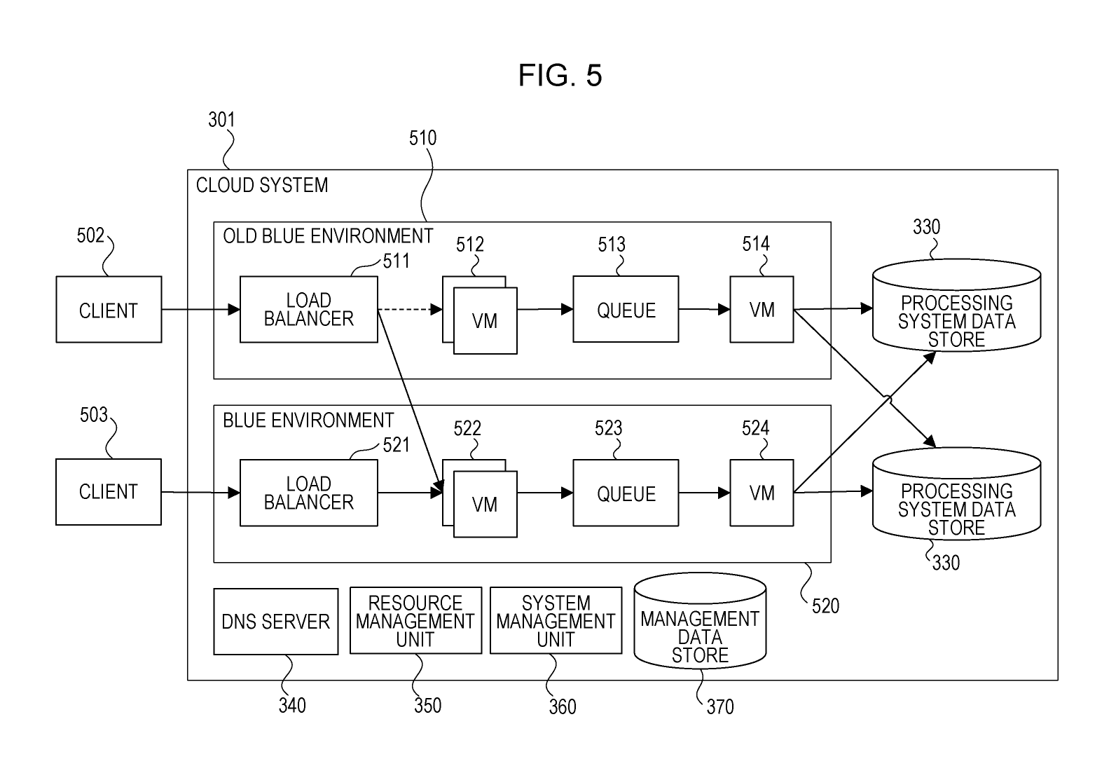

FIG. 5 is a diagram illustrating a configuration of processing environments after execution of the Blue-Green deployment. The term “after execution of the Blue-Green deployment” indicates a time point after association between an official FQDN of a service managed by the cloud system 301 and a DNS name of a load balancer is switched by rewriting the setting file 400 using the setting value updating unit 352. The Blue-Green deployment is simply referred to as “switching” hereinafter.

A client 502 continuously transmits a request to an old processing environment since a DNS cache is not updated in a network environment of the client 502 after the switching, for example. A client 503 appropriately transmits a request to a new processing environment after the switching. A reference numeral 510 indicates the old processing environment after the switching. The old processing environment is also referred to as an “old Blue environment”. On the other hand, a reference numeral 520 indicates the new processing environment, and is also referred to as a “Blue environment” hereinafter. The old Blue environment operates even after the switching.

As described above, the processing environment in the first row of the table 410 of FIG. 4B corresponds to a processing environment of the old Blue environment 510. A load balancer 511 in the old Blue environment corresponds to the load balancer in the column 412 in the processing environment in the first row of the table 410. Since the old Blue environment continuously operates even after the switching, the load balancer 511 receives a request supplied from the client 502. After the switching, the resource operation unit 361 updates a setting value of the load balancer 511 so that the load balancer 511 transfers a request to VMs 522. Furthermore, the resource operation unit 361 updates the setting value of the load balancer 511 so that transfer of a request from the load balancer 511 to VMs 512 is prohibited. Here, the resource operation unit 361 updates the column 416 in the first row (configuration information of the processing environment of the old Blue environment 510) in the table 410 by a value in the column 413 (VMs 522) in the second row (configuration information of the processing environment of the Blue environment 520) as a setting value. By this update, a request is transferred to the Blue environment since an actual request transfer destination is the VMs 522 even when the load balancer 511 which is an endpoint of the old Blue environment 510 receives a request from the client 502. Note that, the VMs 512, a queue 513, and a VM 514 are in operation, and therefore, a request is not newly transferred although a request being processed is normally processed. A reference numeral 520 indicates a new processing environment after the switching and corresponds to the Blue environment as described above. The Blue environment includes a load balancer 521 associated with the official FQDN of the service managed by the cloud system 301.

Furthermore, the processing environment in the second row of the table 410 of FIG. 4B corresponds to the processing environment of the Blue environment 520. The reference numeral 521 indicates the load balancer in the Blue environment. The load balancer 521 receives a request appropriately transmitted since a DNS cache is updated in the network environment of the client 502 after the switching. The load balancer 521 transfers a request of the old Blue environment to the VMs 522, and thereafter, relays the process to a queue 523 and a VM 524. Unlike the old Blue environment 510, in the Blue environment, a request is not required to be transferred from the client 503 to another processing environment, and therefore, the table 410 is not updated.

Note that a client serving as a transmission source may newly obtain a DNS record when the load balancer 511 of the old Blue environment 510 returns an error to the client in response to a request supplied from the client. However, all clients which access the cloud system 301 are required to have such a mechanism.

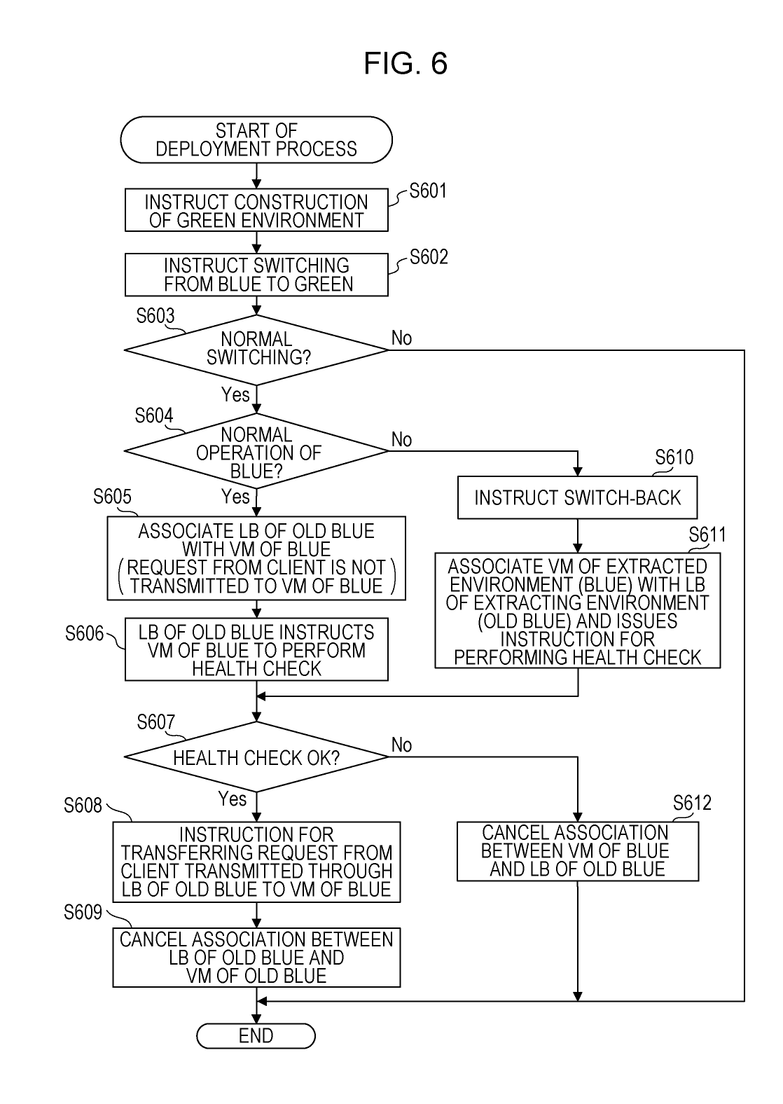

FIG. 6 is a flowchart illustrating a procedure of a deployment process. A process in the flowchart of FIG. 6 is executed by the system management unit 360. Specifically, the process in the flowchart of FIG. 6 is realized when the CPU 203 of the server computer in the data center reads and executes a program recorded in the ROM 204 or the secondary storage device 206.

In step S601, the resource operation unit 361 issues an instruction for constructing the Green environment to the resource generation unit 351. When the Green environment is constructed, information on various computer resources is added to the tables 410 and 420. In step S602, the resource operation unit 361 issues an instruction for executing the Blue-Green switching to the setting value updating unit 352. Specifically, a load balancer which receives a request from a client installed out of the cloud system is changed by updating the setting file of the DNS server 340. In step S603, the resource operation unit 361 issues an inquiry to the setting value updating unit 352, and when it is determined that the switching is successfully performed, a process in step S604 is executed, and otherwise, the process of this flowchart is terminated. In step S604, the test unit 362 determines whether the Blue environment 520 normally operates by performing an operation/communication check test or the like on the Blue environment 520. When the determination is affirmative, the test unit 362 executes a process in step S605, and otherwise, a process in step S610 is executed.

In step S605, the resource operation unit 361 updates the table 410 so that the load balancer 511 of the old Blue environment 510 is associated with the VMs 522 of the Blue environment 520. Specifically, a VM included in the column 413 in the second row of the management table 410 is added to the column 416 in the first row of the management table 410 as a candidate of a request transfer destination. At a time point when the association is performed, health check performed by the load balancer 511 of the old Blue environment 510 on the VMs 522 of the Blue environment 520 is not completed, and therefore, a request from the client 502 is not transferred to the VMs 522 of the Blue environment 520. In step S606, the test unit 362 issues an instruction for performing the health check on the VMs 522 of the Blue environment 520 added in step S605 to the load balancer 511 of the old Blue environment 510. In the health check, it is determined whether the virtual machine normally operates and whether communication with the virtual machine is available. Note that, when the load balancer 511 of the old Blue environment 510 executes the health check on the Blue environment 520, setting values of the load balancers in the old Blue environment 510 and the Blue environment 520 may be different from each other, and therefore, the health check may fail. Accordingly, the test unit 362 may issue an instruction for executing the health check after a setting value of the load balancer 521 of the Blue environment 520 is applied to the load balancer 511 of the old Blue environment 510 based on the information included in the table 420. In step S607, when the test unit 362 determines that a request may be transferred to the VMs 522 of the Blue environment 520 based on a result of the health check executed by the test unit 362 in step S606, a process in step S608 is executed, and otherwise, a process in step S612 is executed. Also when the health check fails, the test unit 362 executes the process in step S612.

In step S608, the resource operation unit 361 instructs the load balancer 511 in the old Blue environment 510 to transfer a request supplied from the client 502 to the VMs 522 in the Blue environment 520 added in step S605. In step S609, the resource operation unit 361 updates the table 410 so that the association between the load balancer 511 in the old Blue environment 510 and the VMs 512 is cancelled so that the request supplied from the client 502 is not transferred to the VMs 512 in the old Blue environment 510. Specifically, the resource operation unit 361 deletes values set in the columns 413, 414, and 415 of the processing environment in the first row of the management table 410 and assign a removal flag so as to update the table 410. If communication from the load balancer 511 to the VMs 512 which are request distribution destinations may be closed by a setting on the load balancer 511, the communication may be only closed without cancelling the association between the load balancer 511 and the VMs 512. Similarly, when the communication is closed, the resource operation unit 361 updates the setting values of the columns 413, 414, and 415 in the management table 410. Thereafter, the deployment process is terminated.

In step S610, the resource operation unit 361 instructs the setting value updating unit 352 to execute update of the setting file 400 which is executed in step S602 again so as to perform switch-back from the Blue environment 520 to the old Blue environment 510. In step S611, the resource operation unit 361 updates the table 410 so that the VMs 512 of the processing environment 510 which has become the Blue environment by the switching is added to the load balancer 521 of the processing environment 520 which has become the old Blue environment by the switching. Note that, at a time point of step S611, a request is not yet transferred from the client to the VMs 512.

In step S612, the resource operation unit 361 updates the table 410 so that the association between the VMs of the Blue environment and the load balancer of the old Blue environment which is externally disclosed is cancelled, and terminates the deployment process. If the health check is not required, the process may proceed to step S608 while step S606 and step S607 are skipped. Furthermore, the load balancer 511 may transfer a request to the VMs 522 without an instruction issued by the resource operation unit 361 to the load balancer 511 in step S608 when the association is made in the table 410 of FIG. 4B.

According to at least this embodiment, even when the setting of reception of a request from a client by the processing environment 520 is stored as a record in the DNS server, the load balancer 511 of the processing environment 510 may receive the request from the client. In this case, according to at least this embodiment, the system management unit 360 associates the load balancer 511 in the processing environment 510 with the VMs 522 in the processing environment 520 and cancels the association between the load balancer 511 in the processing environment 510 and the VMs 512 in the processing environment 510. According to at least this embodiment, a request received by a load sharing apparatus in a processing environment which is not set as a production environment by a DNS server may be processed in VMs in a processing environment set as a production environment.

### Second Embodiment

In at least the first embodiment, a flow of update of setting values for transferring a request from a load balancer to VMs in two environments, that is, a Blue environment and an old Blue environment, after switching is described. However, when upgrading of a processing environment is often performed, three or more environments may exist in parallel. A deployment method for generating a processing environment for each upgrading and deleting an unrequired processing environment is sometimes used. Specifically, when switching of a connection destination is completed in the Blue-Green deployment and it is determined that a system has no failure, an old production environment is no longer required, and therefore, the old production environment may be deleted. Even in such a case, some clients continuously transmit a request to an old processing environment due to the reason described in at least the first embodiment, and therefore, a request transmission destination of such clients is required to be changed to a latest processing environment. In at least a second embodiment, as an application example of at least the first embodiment, a method for managing a plurality of processing environments which are not a production environment is described.

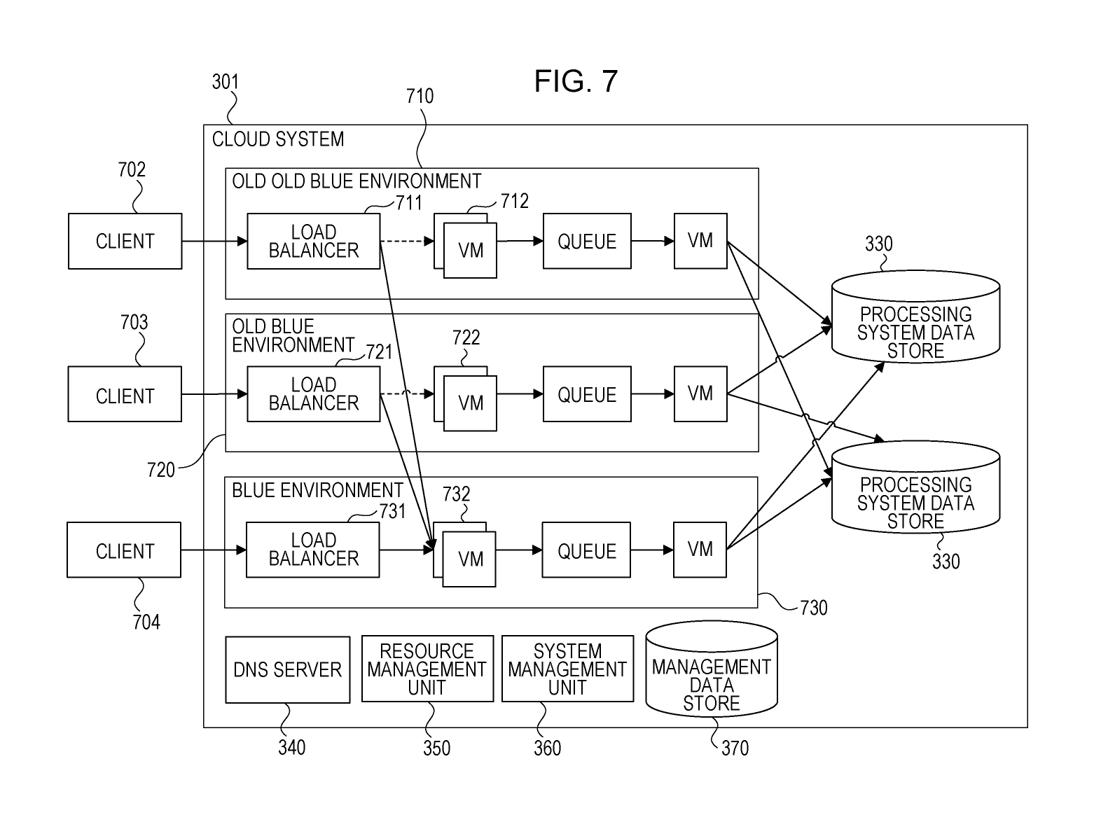

FIG. 7 is a diagram illustrating a cloud system configuration including three or more processing environments after switching. As with at least the first embodiment, clients 702 and 703 continuously transmit requests to old processing environments since a DNS cache is not updated in a network environment of the clients 702 and 703. The client 703 transmits a request to an old Blue environment 720, and the client 702 transmits a request to a further-old processing environment (hereinafter referred to as “old-old Blue”) 710 which is older than the old Blue. A client 704 transmits a request to a Blue environment 730 including a load balancer 731 associated with an official FQDN of a service managed by a cloud system 301. After switching, a resource operation unit 361 updates setting values of load balancers 711 and 721 so that the load balancers 711 and 721 transfer a request to VMs 732. Simultaneously, the resource operation unit 361 updates the setting values of the load balancers 711 and 721 so that the load balancers 711 and 721 do not transfer requests to VMs 712 and 722, respectively.

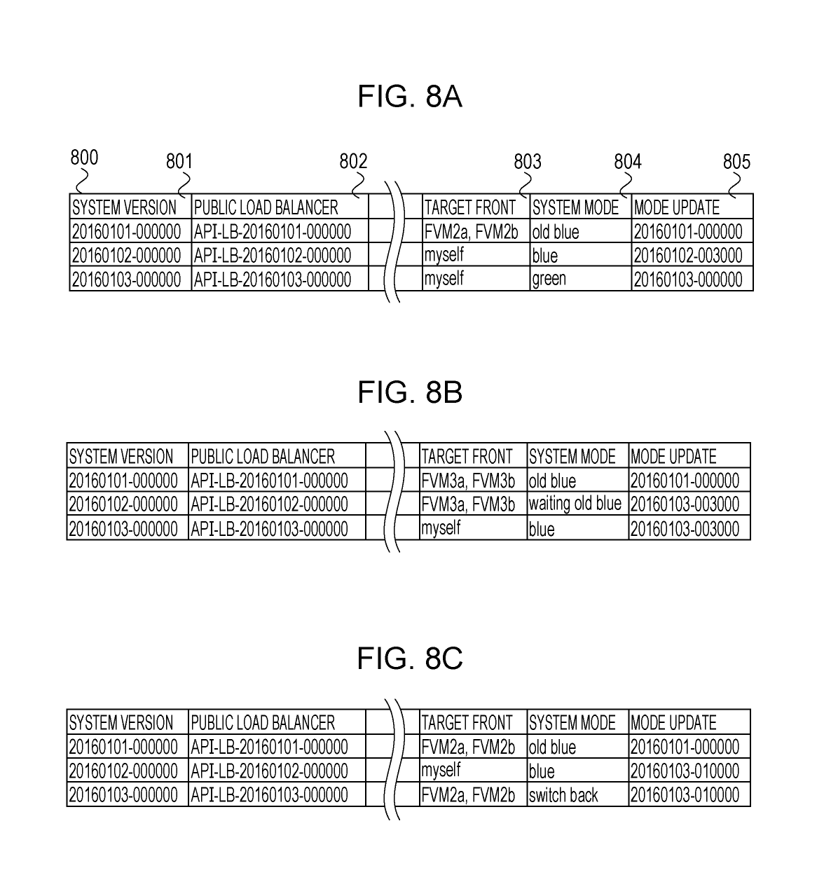

FIGS. 8A to 8C are diagrams illustrating management tables of processing environments for individual processing steps. A management table 800 manages the processing environments for individual versions. Although the management table 800 is generated by expanding the table 410 of FIG. 4B, a newly generated table may be used as the management table 800. The management table 800 is stored in a management data store 370 and updated by the resource operation unit 361 in the steps during deployment.

A column 801 includes a version of a processing environment and corresponds to the column 411 of FIG. 4B. A column 802 includes a unique ID of a load balancer externally disclosed and corresponds to the column 412. A column 803 includes VMs which are destinations of transfer of requests from load balancers 711, 721, and 731 which are externally disclosed and corresponds to the column 416 in FIG. 4B. A column 804 includes a system mode of a processing environment. In this embodiment, five system modes, that is, “old blue”, “blue”, “green”, “waiting old blue”, and “switch-back” are defined for convenience of description. The processing environment “old blue” was operated as a Blue environment in the past. The processing environment “blue” is operated as the Blue environment and includes VMs which are transfer destinations of a request supplied from a load balancer in another processing environment as described in at least the first embodiment. The processing environment “green” is operated as a Green environment, and only the processing environment “green” does not transfer a request to the processing environment “blue”. The processing environment “waiting old blue” was a Blue environment in the past and may return to the Blue environment again when switch-back is performed. A preceding processing environment “blue” is switched to the processing environment “waiting old blue”. After a predetermined period of time, when it is determined that the processing environment “blue” is normally operated, the processing environment “waiting old blue” is changed to the processing environment “old blue”. The predetermined period of time may be one week, one month, or so. The processing environment “switch-back” corresponds to a state in which the Blue environment is entered again due to switch-back when an error occurs in the Blue environment, for example. A column 805 includes an update date and time of a system mode when the system mode is changed.

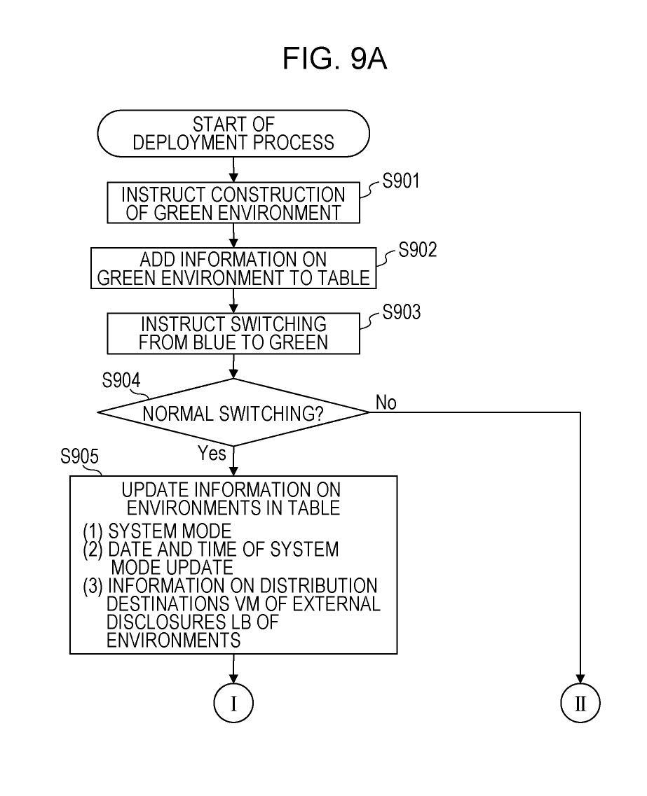

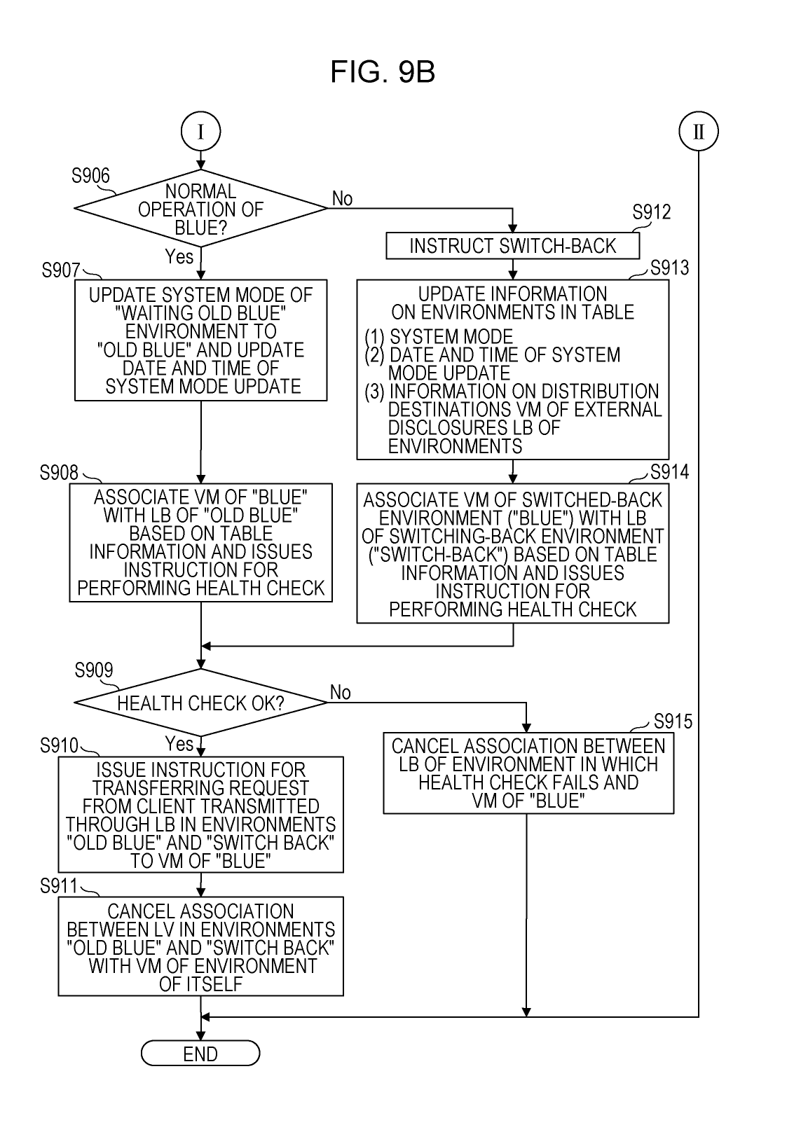

FIG. 8A is a diagram of the management table 800 in a period of time from when the Green environment is constructed to when switching is performed. FIG. 8B is a diagram of the management table 800 in a period of time from when the switching is performed to when it is determined that “blue” is normally operated. FIG. 8C is a diagram of the management table 800 obtained after the switch-back is performed since it is determined that “blue” is not normally operated. Specifically, a state after step S902 of FIG. 9A described below corresponds to FIG. 8A, a state after step S905 corresponds to FIG. 8B, and a state after step S913 corresponds to FIG. 8C.

FIGS. 9A and 9B are a flowchart illustrating a procedure of a series of deployment processes using a management table of processing environments. Specifically, the process in the flowchart of FIGS. 9A and 9B is realized when a CPU 203 of a server computer in a data center reads and executes a program recorded in a ROM 204 or a secondary storage device 206.

In step S901, the resource operation unit 361 issues an instruction for constructing a Green environment to a resource generation unit 351 similarly to the process in step S601. In step S902, the resource operation unit 361 adds the Green environment constructed in step S901 to the management table 800. In step S903, the resource operation unit 361 instructs switching similarly to the process in step S602. In step S904, it is determined whether the switching is successfully performed, and when the determination is affirmative, the process proceeds to step S905, and otherwise, the deployment process is terminated.

In step S905, the resource operation unit 361 updates information on the environments in the management table 800. First, the resource operation unit 361 updates a processing environment corresponding to a system mode 804 of “blue” to a processing environment corresponding to “waiting old blue” and updates a processing environment corresponding to “green” to a processing environment corresponding to “blue”. Subsequently, the resource operation unit 361 updates the system mode update date and time 805 of the processing environment in which the system mode 804 is updated. Finally, the resource operation unit 361 updates VMs of transfer destinations of requests of load balancers in the processing environments updated to the system mode “old blue” and “waiting old” to VMs corresponding to the system mode “blue”. In step S906, it is determined whether the processing environment corresponding to the system mode 804 of “blue” is normally operated. When the determination is affirmative, a process in step S907 is executed, and otherwise, a process in step S912 is executed. The determination as to whether the processing environment is normally operated is made in accordance with a fact that a test executed by the test unit 362 is passed or a fact that an error does not occur when a certain request process is performed after a predetermined period of time.

In step S907, the resource operation unit 361 updates a processing environment corresponding to the system mode 804 of “waiting old blue” to “old blue” and updates the system mode update date and time 805. In step S908, the test unit 362 and the resource operation unit 361 associates a load balancer corresponding to the system mode 804 of “old blue” with VMs corresponding to a system mode “blue” and serving as a request transfer destination. Furthermore, the test unit 362 issues an instruction for executing a health check. In step S909, as with the process in step S607, when the test unit 362 determines that a request may be transferred to VMs corresponding to a system mode of “blue” based on a result of the health check, a process in step S910 is executed, and otherwise, a process in step S915 is executed. Also when the health check fails, the test unit 362 executes the process in step S915.

In step S910, the resource operation unit 361 instructs a combination of the load balancer and the VMs in which the health check is successfully performed in step S909 to transfer a request from the load balancer to the VMs. In step S911, the resource operation unit 361 cancels the association between a load balancer in processing environments corresponding to the system modes 802 of “old blue” and “switch-back” and VMs of the environment itself in accordance with information included in the management table 800. As with the process in step S609, the resource operation unit 361 may only close communication instead of the cancel of the association between the load balancer and the VMs.

In step S912, as with the process in step S610, the resource operation unit 361 executes switch-back. Here, a processing environment corresponding to the system mode 804 of “waiting old blue” enters a Blue environment as a result of the switch-back. In step S913, first, the resource operation unit 361 updates the management table 800 so that a processing environment corresponding to the system mode 804 of “waiting old blue” is updated to “blue” and updates the system mode 804 of “blue” to “switch-back”. Thereafter, the resource operation unit 361 updates the system mode update date and time 805 of the processing environment in which the system mode 804 is changed. Finally, the resource operation unit 361 sets VMs of transfer destinations of a request from the load balancer to VMs of a processing environment corresponding to “blue”. In step S914, the test unit 362 and the resource operation unit 361 add the VMs of the switched-back processing environment (“blue” at this time point) to the load balancer of the switched-back processing environment (“switch-back” at this time point) and execute health check.

In step S915, the resource operation unit 361 cancels the association between the load balancers in processing environments corresponding to “old blue” and “switch-back” in which the health check fails and the VMs corresponding to “blue” which is a request transfer destination.

As described above, if frequency of upgrading of a service is high, the old Blue environment may remain. However, since operation cost becomes high, an unrequired processing environment is preferably deleted in one or more embodiments. A method for deleting computer resources under control of a load balancer which is accessible by a client and which is externally disclosed depending on a condition while only the load balancer remains will be described.

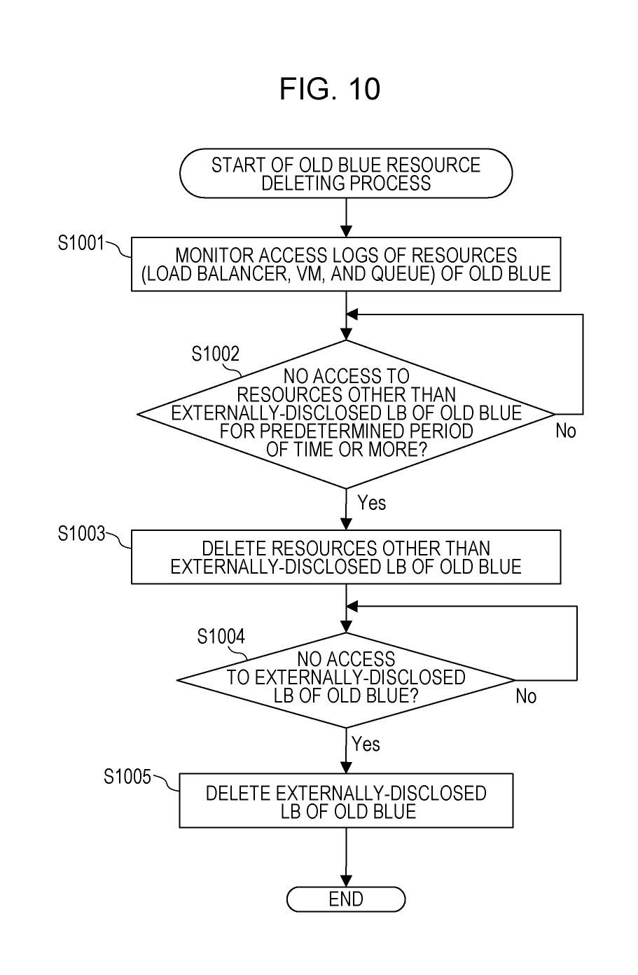

FIG. 10 is a flowchart of a procedure of a process of deleting computer resources of an old Blue environment. In step S1001, the resource monitoring unit 353 monitors use states of various computer resources, an access log, an operation log, and so on of the processing environment corresponding to the system mode 804 of “old blue”. In step S1002, the resource monitoring unit 353 checks use states of computer resources other than the load balancer which is externally disclosed in the processing environment corresponding to the system mode 804 of “old blue”. The resource monitoring unit 353 determines whether a server is not accessed for a predetermined period of time or whether data is not included in a queue. When the determination is negative (i.e., a server is not accessed or data is not included in a queue), a process in step S1003 is executed. Otherwise, the resource monitoring unit 353 checks the use states of the computer resources and logs again after a certain period of time. In step S1003, computer resources other than the load balancer which is externally disclosed in the processing environment corresponding to the system mode 804 of “old blue” are deleted. In step S1004, an access log of a load balancer which is externally disclosed in the processing environment corresponding to the system mode 804 of “old blue” is checked. If an access log may not be detected for a predetermined period of time or more, a process in step S1005 is executed, and when an access log is detected within the predetermined period of time, the resource monitoring unit 353 checks the access log of the load balancer again after a certain period of time. In step S1005, the load balancer which is externally disclosed in the processing environment corresponding to the system mode 804 of “old blue” is deleted.

Note that, in step S1003, if a message still remains in a queue of the old Blue environment, only the VMs 722 in the old Blue environment may be deleted and the queue in the old Blue environment and a VM which processes the message in the queue may not be deleted.

According to at least this embodiment, in a case where three processing environments are generated in parallel in the cloud system, the system management unit 360 associates a load sharing apparatus in two of the processing environments which is not set as a production environment by the DNS server with virtual machines in the other one of the processing environments set as the production environment. Furthermore, the system management unit 360 deletes virtual machines in the processing environments which are not set as the production environment. According to at least this embodiment, a request received by a load sharing apparatus in a processing environment which is not set as a production environment by a DNS server may be processed in VMs in a processing environment set as a production environment.

### Other Embodiments

Embodiment(s) of the present disclosure may also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-230824 filed Nov. 29, 2016, which is hereby incorporated by reference herein in its entirety.

What is claimed is:

1. A management system which manages a plurality of processing environments each of which at least includes a plurality of virtual machines capable of processing a request from a client and a load sharing apparatus which transfers the request to the plurality of virtual machines, the management system comprising:
a management unit configured to determine one of the virtual machines to which the request is transferred from the load sharing apparatus,
wherein the management unit transfers the request from a load sharing apparatus in a first processing environment to a virtual machine in a second processing environment which is different from the first processing environment when a setting of an apparatus which receives the request from the client is switched from the load sharing apparatus in the first processing environment to a load sharing apparatus in the second processing environment, and does not transfer the request from the load sharing apparatus in the first processing environment to a virtual machine in the first processing environment.

2. The management system according to claim 1, further comprising:
a first instruction unit configured to instruct the load sharing apparatus in the first processing environment to perform a determination as to whether the request is to be transferred to a virtual machine serving as a candidate of a transfer destination,
wherein when it is determined that the request is to be transferred from the load sharing apparatus in the first processing environment to the virtual machine in the second processing environment based on the instruction, the request received by the load sharing apparatus in the first processing environment is transferred to the virtual machine in the second processing environment.

3. The management system according to claim 2, wherein the management unit prohibits transfer of the request from the load sharing apparatus in the first processing environment to the virtual machine in the first processing environment when it is determined that the request is to be transferred from the load sharing apparatus in the first processing environment to the virtual machine in the second processing environment based on an instruction issued by the first instruction unit.

4. The management system according to claim 1, wherein the setting of the apparatus which receives the request from the client is stored in a domain name system (DNS) server which is accessible by the management system.

5. The management system according to claim 1, further comprising:
a second instruction unit configured to instruct a resource management unit to execute generation or deletion of a virtual machine,
wherein the second instruction unit instructs the resource management unit to delete the virtual machine in the first processing environment when a first predetermined period of time is elapsed after the setting of an apparatus which receives the request from the client is switched from the load sharing apparatus in the first processing environment to the load sharing apparatus in the second processing environment.

6. The management system according to claim 5,
wherein the second instruction unit is further capable of instructing the resource management unit to generate or delete a load sharing apparatus, and
the second instruction unit instructs the resource management unit to delete the load sharing apparatus in the first processing environment when a second predetermined period of time which is longer than the first predetermined period of time is elapsed after the setting of the apparatus which receives the request from the client is switched from the load sharing apparatus in the first processing environment to the load sharing apparatus in the second processing environment.

7. The management system according to claim 6, wherein the second instruction unit instructs the resource management unit to delete the load sharing apparatus in the first processing environment when the load sharing apparatus in the first processing environment has not received a request from the client when the second predetermined period of time is elapsed after the setting of the apparatus which receives the request from the client is switched from the load sharing apparatus in the first processing environment to the load sharing apparatus in the second processing environment.

8. The management system according to claim 1, wherein a version of an application operating in the virtual machine in the second processing environment is newer than a version of an application operating in the virtual machine in the first processing environment.

9. The management system according to claim 8, wherein a plurality of first processing environments exist.

10. The management system according to claim 1, wherein when the setting of the apparatus which receives the request from the client is switched from the load sharing apparatus in the first processing environment to the load sharing apparatus in the second processing apparatus, and thereafter, switched to the load sharing apparatus in the first processing environment, the management unit:
causes the load sharing apparatus in the first processing environment to transfer the request to the virtual machine in the first processing environment, causes the load sharing apparatus in the first processing environment not to transfer the request to the virtual machine in the second processing environment, causes the load sharing apparatus in the second processing environment to transfer the request to the virtual machine in the first processing environment, and causes the load sharing apparatus in the second processing environment not to transfer the request to the virtual machine in the second processing environment.

11. A method for controlling a management system which manages a plurality of processing environments each of which at least includes a plurality of virtual machines capable of processing a request from a client and a load sharing apparatus which transfers the request to the plurality of virtual machines, the method comprising:
determining a virtual machine to which the request is transferred from the load sharing apparatus,
wherein the request is transferred from a load sharing apparatus in a first processing environment to a virtual machine in a second processing environment which is different from the first processing environment when a setting of an apparatus which receives the request from the client is switched from the load sharing apparatus in the first processing environment to a load sharing apparatus in the second processing environment, and is not transferred from the load sharing apparatus in the first processing environment to the virtual machine in the first processing environment.
